(19) United States
(12) Patent Application Publication
(10) Pub. No.: US 2009/0038400 A1
(43) Pub. Date: Feb. 12, 2009

(54) Pressure Sensing Devices and Fluid Assemblies

(75) Inventors: Peter Van Vessem, Oldsmar, FL (US); Roger Massicotte, Port Richey, FL (US); Gary Rosenberg, Safety Harbor, FL (US)

Correspondence Address: LEYDIG VOIT & MAYER, LTD, 700 THIRTEENTH ST. NW, SUITE 300, WASHINGTON, DC, 20005-3960, US

(73) Assignee: PALL CORPORATION, East Hillls, NY (US)

(21) Appl. No.: 11/662,664

(22) PCT Filed: Sep. 8, 2005
(86) PCT No.: PCT/US05/31998

§ 371 Date: Mar. 13, 2007

Related U.S. Application Data
(60) Provisional application No. 60/608,876, filed on Sep. 13, 2004.

(51) Int. Cl. G01L 9/00

(52) U.S. Cl. 73/723

(57) ABSTRACT

Pressure sensing devices and fluid assemblies may sense fluid pressure, including, for example, a difference in pressure, or differential pressure, between a fluid at a first pressure and a fluid at a second pressure. The fluid may be a gas, a liquid, or a mixture of gases, liquids, and/or solids.

This application claims priority based on U.S. Provisional Application No. 60/608,876, which was filed on Sep. 13, 2004, and which is incorporated by reference in its entirety for any and all purposes.

### DISCLOSURE OF THE INVENTION

The invention relates to pressure sensing devices and fluid assemblies. For example, devices and assemblies embodying the invention may be used to sense the difference in pressure, i.e., the pressure differential, between a fluid at a first pressure and a fluid at a second pressure. The fluid may be a gas, a liquid, or a mixture of gases, liquids, and/or solids.

In accordance with one aspect of the invention, a pressure sensing device may comprise a housing, a deflectable element, a deflection sensing circuit, and a layer of solid, insulative material. First and second fluid passages are associated with the housing, and the deflectable element has first and second opposite sides. The deflectable element is mounted to the housing with the first side coupled to the first fluid passage and the second side coupled to the second fluid passage. When a fluid at a first pressure is directed along the first fluid passage, the first pressure is applied against the first side of the deflectable member. When a fluid at a second pressure is directed along the second fluid passage, the second pressure is applied against the second side of the deflectable member. The deflectable member may then deflect toward the first fluid passage if the second pressure is greater than the first pressure or toward the second fluid passage if the first pressure is greater than the second pressure. The amount of deflection will depend on the pressure differential. The deflection sensing circuit and the solid, inorganic, insulative layer are supported by the first side of the deflectable element. The deflection sensing circuit senses the deflection of the deflectable element and, therefore, the differential pressure. The solid, insulative layer overlies the deflection sensing circuit to electrically insulate the deflection sensing circuit from the first fluid passage and any fluid in the first fluid passage.

In accordance with another aspect of the invention, a pressure sensing device may comprise a housing, a deflectable metal diaphragm, a mechanical stop, a deflection sensing circuit, a ring seal, and an electrical connector. The housing has a metal portion, and first and second fluid passages are associated with the housing. The deflectable metal diaphragm has first and second opposite sides. The deflectable metal diaphragm is mounted to the metal portion of the housing with the first side of the diaphragm coupled to the first fluid passage and the second side coupled to the second fluid passage. Again, when a fluid at a first pressure and a fluid at a second pressure are directed along the first and second fluid passages, the first and second pressures are respectively applied against the first and second opposite sides of the deflectable metal diaphragm, deflecting the diaphragm in accordance with the differential pressure. The mechanical stop is associated with the first side of the diaphragm and is arranged to limit the deflection of the diaphragm toward the first fluid passage a predetermined value. The deflection sensing circuit, which is supported by the first side of the deflectable metal diaphragm, includes first and second thin insulative layers and a thin-film strain gauge circuit positioned between the first and second insulative layers. The deflection sensing circuit, including the strain gauge circuit, senses the amount of deflection of the deflectable metal diaphragm and, therefore, the differential pressure. The seal is positioned between the housing and the first side of the deflectable metal diaphragm, defining an inner region and an outer region of the first side of the diaphragm. The inner region includes at least a portion of the strain gauge circuit and is coupled to the first fluid passage, while the outer region is isolated from the first fluid passage by the seal. Thus, the fluid in the first fluid passage exerts the first pressure against the first side of the deflectable metal diaphragm, and the insulative layers of the deflection sensing circuit electrically insulate the strain gauge circuit from the fluid in the first passage and from the deflectable metal diaphragm. The electrical connector is associated with the strain gauge circuit and extends between the inner and outer regions of the first side of the deflectable metal diaphragm.

In accordance with another aspect of the invention, a pressure sensing assembly may comprise a fitting, deflectable element, a deflection sensing circuit, an insulative layer, and a receptacle. A first fluid passage and a second fluid passage are associated with the fitting, and the deflectable element has a first and second opposite sides. The deflectable element is mounted to the fitting with the first side coupled to the first fluid passage and the second side coupled to the second fluid passage. Again, when a fluid at a first pressure and a fluid at a second pressure are directed along the first and second fluid passages, the first and second pressures are respectively applied against the first and second opposite sides of the deflectable element, deflecting the deflectable element in accordance with the differential pressure. The deflection sensing circuit, which is supported on the first side of the deflectable element and includes a thin-film strain gauge circuit, senses the deflection of the deflectable element and, therefore, the differential pressure. The insulative layer is also supported by the first side of the deflectable element and overlies the deflection sensing circuit to electrically insulate the deflection sensing circuit from the first fluid passage and any fluid in the first fluid passage. The receptacle includes a pressure sensing port having a well. The well of the pressure sensing port receives the fitting with the deflectable element positioned within the well. The receptacle fluidly connects the first fluid passage of the fitting to a source of the fluid at the first pressure and the second fluid passage of the fitting to a source of the fluid at the second pressure.

Pressure sensing devices and fluid assemblies embodying one or more aspects of the invention have many advantages. For example, with an insulative layer overlying the deflection sensing circuit and supported by the deflectable element, the deflection sensing circuit is electrically insulated from any fluid which might damage the deflection sensing circuit. Fluids can be coupled to both sides of the deflectable element or diaphragm, and the first and second pressures can be directly applied to both sides of the deflectable element or diaphragm, without the use of additional protective features, such as isolating diaphragms, intermediate dielectric liquids, and complex manifold arrangements. This not only substantially reduces the size, weight, and complexity of the devices and assemblies embodying the invention, it also significantly enhances their reliability and responsiveness.

### DESCRIPTION OF THE DRAWINGS

FIG. 1A is a cross sectional elevation view of a pressure sensing device and

FIG. 1B is a cross sectional elevation view of the pressure sensing device rotated by 90°.

FIG. 2 is a plan view of a deflectable element, a deflection sensing circuit, and an overlying insulative layer.

FIG. 3 is a cross sectional elevation view of a portion of a deflectable element and a deflection sensing circuit with the thicknesses exaggerated for clarity.

FIG. 4 is a cross sectional elevation view of a fluid assembly.

FIG. 5 is a cross sectional elevation view of a fluid assembly.

### DETAILED DESCRIPTION OF THE EMBODIMENTS

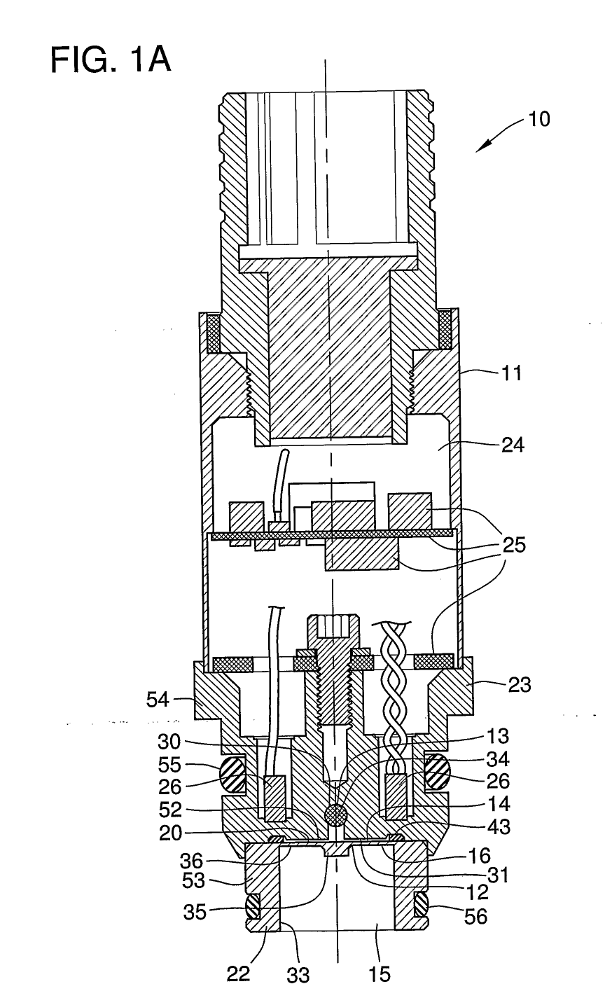

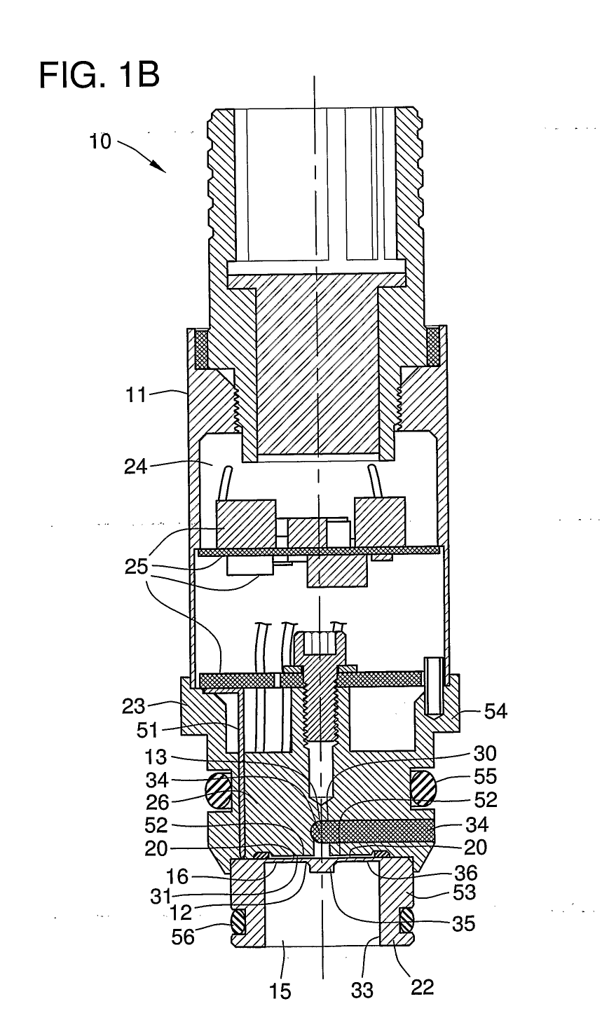

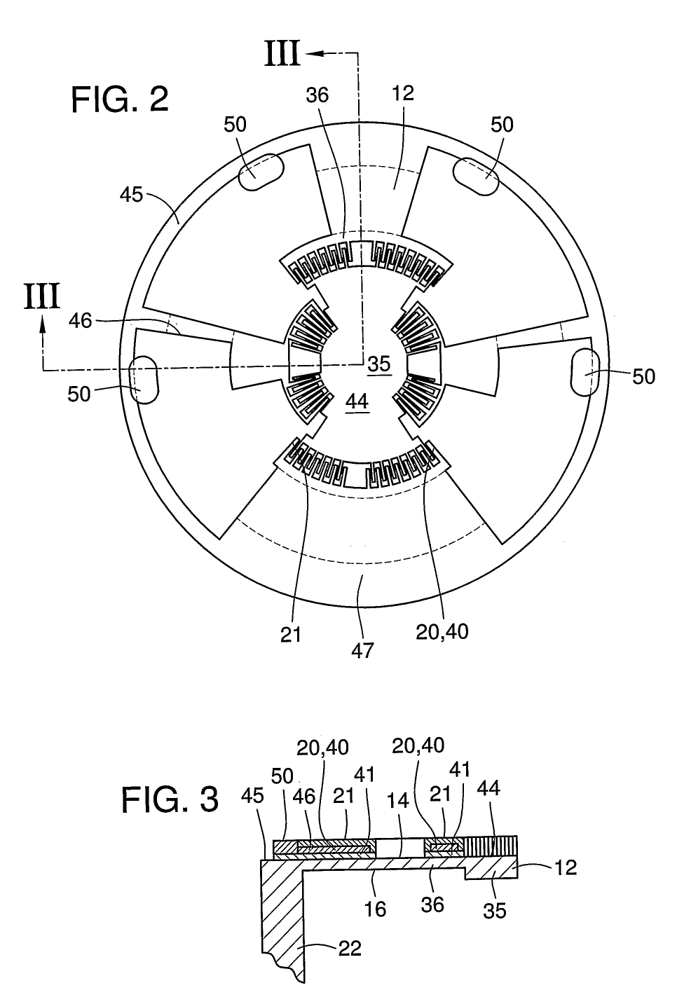

Pressure sensing devices and assemblies embodying one or more aspects of the invention may be structured in a wide variety of ways. One of many examples of a pressure sensing device 10 is shown in FIGS. 1A-3. The illustrated pressure sensing device 10 includes a housing 11 and a deflectable element 12 mounted to the housing 11. The housing 11 includes a first fluid passage 13 which is coupled to one side, e.g., the outboard side 14, of the deflectable element 12 and a second fluid passage 15 coupled to the opposite side, e.g., the inboard side 16, of the deflectable element 12. A deflection sensing circuit 20 is supported by the outboard side 14 of the deflectable element 12. An electrically insulative layer 21 overlies the deflection sensing circuit 20 and is also supported by the outboard side 14 of the deflectable element 12.

A fluid at a first pressure may be directed along the first fluid passage 13, applying the first pressure directly against the outboard side 14 of the deflectable element 12. A fluid at a second pressure may be directed along the second fluid passage 15, applying the second pressure directly against the inboard side 16 of the deflectable element 12. The deflectable element 12 deflects in proportion to the pressure differential. The deflection sensing circuit 20 senses the deflection and, therefore, the differential pressure. The insulative layer 21 protects the deflection sensing circuit 20, for example, by electrically insulating the deflection sensing circuit 20 from the fluid in the first fluid passage 13.

The housing of the pressure sensing device may be fashioned from any material which has sufficient structural integrity and is sufficiently impervious, such as a metallic material or a polymeric material, and may be configured in numerous ways. The housing may be a single piece structure or a multipiece structure. As shown in FIGS. 1A and 1B, the housing 11 may comprise several pieces, including mating inboard and outboard pieces 22,23 between which the deflectable element 12 may be located. The housing 11 may define a chamber 24 in which various electronic components 25, such as printed circuit boards, interfaces, signal conditioners and amplifiers, may be located. The electronic components may serve a variety of purposes. For example, they may be used to calibrate the pressure sensing device or for signal conversion, e.g., to convert a strain gauge signal to other formats such as voltage or current. One or more temperature sensors 26 may also be located in the chamber 24 preferably in the vicinity of the first fluid passage 13. The temperature sensors may also serve a variety of purposes. For example, they may be used to compensate the pressure sensing device for change in output due to temperature changes or to provide an independent indication of temperature as an output. The chamber 24 may be filled with a thermally conductive, electrically insulative material such as silicone.

The first and second fluid passages may be variously configured and may be associated with the housing in several ways. As shown in FIGS. 1A and 1B, for example, the first and second fluid passages may extend through the housing. For instance, the first fluid passage 13 may comprise a radial channel 30 which extends radially between the outer surface and the center of the outboard housing piece 23, a gap 31 between the outboard side 14 of the deflectable element 12 and the outboard housing piece 23, and an axial channel 32 which extends between the gap 31 and the inner end of the radial channel 30. The second fluid channel 15 may comprise a bore 33 which extends from the inboard end of the inboard housing piece 22 to the deflectable element 12. To prevent foulants from collecting in the fluid passages, one or both passages, e.g., the first fluid passage 13, may contain a porous material 34 to filter the foulants from fluid flowing along the passages. While the first and second fluid passages may comprise the channels, gap and bore shown in FIGS. 1A and 1B, the first and second fluid passages may alternatively comprise any other channels, grooves, crevices, chambers, spaces or openings which allow fluid to fluidly communicate with, for example, contact, the opposite sides of the deflectable element. For example, the deflectable element may be located at one end of the housing with the outboard side of the deflectable element facing the housing and the inboard side facing away from the housing. The first fluid passage may be a passage which extends within the housing and fluidly communicates with the outboard side of the deflectable element, and the second fluid passage may be a space at the end of the housing which faces the inboard side of the deflectable element.

The deflectable element may be variously configured. For example, the deflectable element may comprise a thin, regularly or irregularly shaped diaphragm which can deflect upon application of a pressure differential on both sides of the diaphragm. The thickness may be uniform or non-uniform. In the embodiment illustrated in FIGS. 1A-3, the deflectable element 12 may comprise a thin, circular diaphragm having a thickened center section 35 and a thinner annular section 36 surrounding the thickened section 35. The thickened section 35 concentrates the deflection in the thinner annular section 36, which can enhance the sensitivity of the pressure sensing device 10. The thickened section 35 may have a generally uniform thickness in the range from about 0.035 inch or less to about 0.050 inch or more, and the thinner annular section 36 may have a generally uniform thickness in the range from about 0.007 inch or less to about 0.014 inch or more. While the thickened section may protrude on both sides of the diaphragm, it preferably protrudes on only one side. For example, the thickened section 35 may protrude on only the inboard side 16 of the diaphragm 12, leaving the outboard side 14 generally flat.

The deflectable element 5 may be fashioned from any suitably deflectable material, including, for example, silicon, sapphire, a metal, an elastomer, or a polymer, and may be a single or multi piece structure distinct from the housing. For many embodiments, the deflectable element and the housing are fashioned from materials having similar coefficients of thermal expansion to reduce thermal stress. The deflectable element may be mounted in a variety of ways and in a variety of locations to the housing with the outboard and inboard sides coupled to the first and second fluid passages. For example, the deflectable element may be welded, bonded or mechanically connected to the housing at either end of the housing or intermediate the ends of the housing. Further, the deflectable element may be mounted generally perpendicular to a longitudinal axis of the housing, generally parallel to a longitudinal axis o the housing, or at any angle between perpendicular and parallel.

In the embodiment as shown in FIG. 1A-3, the deflectable element 12 may be a unitary portion of the housing 11, including, for example, a unitary portion of the outboard piece 23 or the inboard piece 22, e.g., the inboard piece 22. The bore 33 may be drilled from the inboard end of the inboard piece 22, terminating short of the outboard end. The diaphragm 12 may then be machined at the outboard end of the inboard piece 22. The diaphragm 12 may thus be unitarily mounted integrally to the inboard piece 22 of the housing 11, which matches the thermal coefficients of expansion and eliminates the need for a seal between the inboard piece 22 and the diaphragm 12. The outboard housing piece 23 may also be fashioned from a metal having a coefficient of thermal expansion similar to, e.g., generally equal to, the metal of the inboard housing piece 22. Matching the thermal coefficients of expansion reduces thermal stress and enhances performance. The inboard housing piece 22 may then be attached to the outboard housing piece 23 with the diaphragm 12 between them. The inboard and outboard pieces may be threaded to one another. Alternatively, the two pieces 22, 23 may be welded to one another with the outboard side 14 of the diaphragm 12 facing the gap 31 of the first fluid passage 13 and the inboard side 16 facing the bore 33 of the second fluid passage 15. The inboard and outboard pieces 22, 23 may be fusion welded by a variety of techniques, including laser, election beam, or TIG welding. Welding the pieces 22, 23 eliminates a seal and simplifies the construction.

The deflection sensing circuit 20 may be configured in any manner which enables the deflection of the deflectable element 12 to be sensed. For example, the deflection sensing circuit 20 may have an electrical parameter which changes in response to deflection of the deflectable element 12. For many embodiments, the deflection sensing circuit 20 may comprise a strain gauge circuit 40, such as a thin-film strain gauge circuit, which includes a resistance network that changes resistance in proportion to the deflection of the deflectable element.

The deflection sensing circuit may be supported by one or both sides of the deflectable element. For many embodiments, the deflection sensing circuit 20 may be supported by only one side of the deflectable element 12, e.g., the side closest to the electronic components 25. In the embodiment shown in FIGS. 1A-3, the thin-film strain gauge circuit 40 may be supported by the outboard side 14 of the diaphragm 12 and at least a portion of the strain gauge circuit 40 may be supported in the thin annular section 36 of the diaphragm 12. Further, the deflection sensing circuit may be supported by the deflectable element in a variety of ways. For example, the deflection sensing circuit may be mounted directly on the deflectable element, especially if the deflectable element is fashioned from an insulative material. As another example, the deflection sensing circuit may be mounted directly on one or more intermediate layers which, in turn, are mounted on the deflectable element. In the embodiment shown in FIGS. 1A-3, the thin-film strain gauge circuit 40 may be mounted directly on an underlying insulative layer 41 which, in turn, may be mounted directly on the outboard side 14 of the metal diaphragm 12. The underlying insulative layer 41 may be formed from any sufficiently insulative material, including a solid inorganic material, such as glass. The underlying insulative layer 41, and the thin-film strain gauge circuit 40, may be deposited in any suitable manner, including, for example, by sputtering or chemical vapor deposition.

The deflection sensing circuit 20 may be supported by one or both sides of the deflectable element 12 facing one or both adjacent fluid passages 13, 15. To electrically insulate the deflection sensing circuit 20 from the fluid passages 13, 15, and any fluid in the fluid passages 13, 15, an insulative layer 21 which is supported by the deflectable element 12 overlies the deflection sensing element 20. The overlying insulative layer 21 may also be fashioned from any suitably insulative material, including a solid, inorganic material, such as glass. In the embodiment shown in FIGS. 1A-3, the overlying insulative layer 21 may be formed as a component of the deflection sensing circuit 20. For example, the underlying insulative layer 41, the thin-film strain gauge circuit 40, and the overlying insulative layer 21 may be deposited sequentially on the diaphragm 12. In other embodiments, the overlying insulative layer may be a component distinct from the deflection sensing circuit. The overlying insulative layer, as well as the underlying insulative layer, may extend over an entire side of the deflectable element or only a portion of the deflectable element, e.g., the portion occupied by the deflection sensing circuit.

Electrical signals may be supplied to or from the deflection sensing circuit in any of numerous ways. For example, the deflection sensing circuit may be electrically coupled via a wireless connection to other electrical components within the pressure sensing device or elsewhere. Alternatively, the deflection sensing circuit may be electrically coupled to other electrical components by one or more electrical connectors. The electrical connectors may be variously configured and may be routed to and/or from the deflection sensing circuit in a variety of ways.

For many embodiments, the deflection sensing circuit may be electrically coupled to other electrical components via one or more electrical connectors positioned on the same side of the deflectable element as the deflection sensing circuit and in a region isolated from the fluid passages. For example, in the embodiment shown in FIGS. 1A-3, a seal 43 may be sealingly positioned between the housing 11 and the deflectable element 12, e.g., between the outboard housing piece 23 and the generally flat outboard side 14 of the diaphragm 12. The seal may have any of a variety of geometries. For some embodiments, the seal may comprise a ring seal, such as an O-ring seal or a ring gasket. The ring seal 43 may seal directly against the diaphragm 12 and/or the deflection sensing circuit 20, which form a seal seat 47. The ring seal 43 defines an inner region 44 and an outer region 45 of the deflectable element 12. The inner region 44 may include at least a portion of the deflection sensing circuit 20, e.g., the thin-film strain gauge circuit 40, and at least a portion of the thinner annular section 36 of the diaphragm 12. The inner region 44 may be coupled to the first fluid passage 13. The outer region 45 may be isolated from the first fluid passage 13 and any fluid in the first fluid passage 13 by the seal ring 43. One or more electrical connectors 46 may extend between the inner region 44 and the outer region 45, for example, along the deflectable element 12 under the ring seal 43. The electrical connector 46 may be a portion of the deflection sensing circuit 20, e.g., a portion of the strain gauge circuit 40, which extends under the ring seal 43. Alternatively, the electrical connector 46 may be a separate conductor which is coupled to the deflection sensing circuit 20, e.g., the strain gauge circuit 40, and extends under the ring seal 43. For many embodiments, the electrical connector 46 may be deposited on the deflectable element 12 with the thin-film strain gauge circuit 40 and sandwiched between the underlying and overlying insulative layers 41, 21. In the embodiment shown in FIGS. 1A-3, the electrical connector 46 may be coupled to one or more contact pads 50 in the isolated outer region 45. Additional electrical connectors 51, such pins, wires, or ribbons, may extend from the contact pads 50 through the outboard housing piece 23 to the electronic components 25. In the embodiment illustrated in FIGS. 1A-3, the additional electrical connectors 51 may comprise insulated, spring-loaded electrical probes. Isolating fluid in the fluid passages from the electrical connectors 46, 50, 51 and their interconnections significantly enhances the reliability of the pressure sensing device.

Pressure sensing devices embodying the invention may be operated in numerous ways. In one mode of operation, fluid at a lower pressure may be directed along the first fluid passage 13 and fluid at a higher pressure may be directed along the second fluid passage 15. The lower pressure fluid is thus coupled to the outboard side 14 of the deflectable element 12 while the higher pressure fluid is coupled to the inboard side 16 of the deflectable element 12. One advantage of this mode of operation is that the weld between the inboard and outboard pieces 22, 23 is maintained in compression by the differential pressure, which enhances the durability and reliability of the pressure sensing device.

With the low pressure fluid and the high pressure fluid respectively coupled to the outboard and inboard sides 14, 16 of the deflectable element 12, the deflectable element 12 deflects toward the gap 31 of the first fluid passage 13 and the outboard piece 23 of the housing 11. For many embodiments, the amount of deflection may be limited by a stop 52. The stop 52 may be arranged to allow the deflectable element 12 to deflect freely over a normal operating range but to contact the deflectable element 12 and limit further deflection beyond the normal operating range. For example, the stop 52 may be arranged to limit the deflection of the deflectable element to a predetermined value. The predetermined value may vary for different diaphragm configurations and may depend on several factors, including, for example, the diameter of the diaphragm, the diameter of the thickened section, the thickness of the annular section, and the diaphragm material. For some embodiments, the predetermined value may be about 0.010 inch or less, or about 0.005 inch or less, or about 0.003 inch or less, e.g., about 0.002 inch or less. The stop thus protects the deflectable element from over-pressure or line pressure in second fluid passage. For example, the pressure sensing device may be used to measure differential pressures on the order of 100 psid for fluids which may have a line pressure on the order of 5000 psi. If the first fluid passage were to leak to atmosphere, the differential pressure across the deflectable element would be about 5000 psid and the stop would prevent undue deflection of the deflectable element. The stop and the small gap width allow the pressure sensing device to be used in environments where the ratio of over-pressure or line pressure to nominal differential pressure is up to about 50:1 or even greater than about 50:1.

The stop may be configured in a variety of ways and may be located in a variety of positions. For example, the stop may be an additional mechanical structure mounted to the housing or the deflectable element. For many embodiments, the stop may comprise an existing portion of the housing or the deflectable element, eliminating the need for additional structure and, thereby, reducing both the size and weight of the pressure sensing device. For example, in the embodiment shown in FIGS. 1A-3, the stop 52 may comprise the inboard end of the outboard piece 23 of the housing 11 on the opposite side of the gap 31 from the outboard side 14 of the diaphragm 12. The depth of the gap 31, e.g., about 0.002 inch, thus limits the amount of deflection of the diaphragm 12.

The deflectable element 12 deflects in proportion to the differential pressure, and the deflection sensing circuit 20 senses the deflection and provides an electrical signal indicative of the differential pressure. For example, the thin-film strain gauge circuit 40 may have a resistance network which changes resistance in proportion to the amount of deflection and provides a corresponding electrical signal indicative of the differential pressure. The electrical signal may be sent to an electrical system which monitors the differential pressure via the electrical connectors 46, 51 and electronic components 25.

Pressure sensing devices embodying the invention allow the low pressure fluid and the high pressure fluid to be directly coupled to both sides of the deflectable element, i.e., the fluids contact both sides of the deflectable element or contact a structure, such as the thin-film strain gauge circuit and the insulative layers, which is supported by one or both sides of the deflectable element. The pressures of the fluids are applied directly against both sides of a deflectable element without the use of additional protective features, such as isolating diaphragms, intermediate dielectric liquids, and complex manifold arrangements which direct the low pressure fluid and the high pressure fluid to separate sensing diaphragms. Pressure sensing devices embodying the invention thus provide a rapidly responsive, highly accurate indication of differential pressure in a small, light-weight package.

Pressure sensing devices embodying the invention may be used in a wide variety of fluid assemblies. For example, many fluid assemblies include filter elements to filter impurities from fluids flowing through the fluid assemblies. The filter element may be used to remove impurities, for example, from hydraulic liquids or lubricant liquids. The pressure sensing device may be used in such a fluid assembly to monitor the differential pressure across the filter element and determine if the filter element should be replaced by a clean filter element. For many embodiments, the pressure sensing device may be small enough to fit the active portion of the device, e.g., the deflectable element and the deflection sensing circuit, into the pressure sensing port of the fluid assembly.

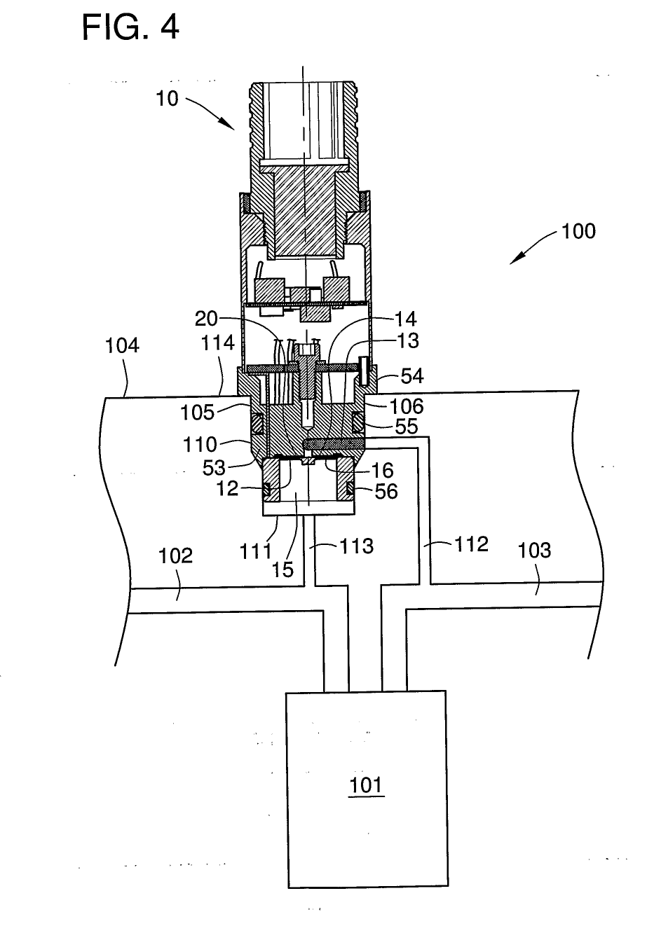

For example, the fluid assembly 100 shown in FIG. 4 includes a filter element 101 and an inlet line 102 and an outlet line 103 connected to the filter element 101. The fluid assembly 100 also includes a receptacle 104 which receives a pressure sensing device 10. The receptacle 104 may be part of any structure of the fluid assembly 100 and may include pressure sensing port 105 which comprises a well 106. The well 106 may be configured in a variety of ways. For example, the well 106 may have one or more cylindrical walls 110 and may terminate at a base 111. A first channel 112 may extend from one line, e.g., the lower pressure outlet line 102, to the cylindrical wall 110 of the well 106, while a second channel 113 may extend from another line, e.g., the higher pressure inlet line 103, to the base 11 of the well 106. The outboard end of the well 106 opposite the base 111 may be surrounded by a ledge 114.

The pressure sensing device, for example, a pressure sensing device 10 similar to that shown in FIGS. 1A and 1B, may be mounted to the receptacle 104 in any convenient manner, e.g., by a threaded connection (not shown). All or a portion of the housing 11 of the pressure sensing device 10 may be configured as a fitting 53 which may be inserted in the well 106 of the pressure sensing port 105 with the first channel 112 fluidly coupled to the first fluid passage 13 and the second channel 113 fluidly coupled to the second fluid passage 15.

The fitting 53 may be variously configured. In the embodiment shown in FIG. 4, the fitting 53 may have a generally cylindrical outer surface which extends from a flange 54 to the inboard end of the fitting 53. The first fluid passage 13 may intersect the cylindrical outer surface of the fitting 53 and the second fluid passage 15 may open onto the inboard end of the fitting 53. The outer diameter of the fitting 53 may be about equal to the inner diameter of the cylindrical wall 110 of the well 106 of the receptacle 104. The fitting 53 may be inserted into the well 105 with the flange 54 abutting the ledge 114, with the first channel 112 fluidly communicating with the first fluid passage 13, and with the second channel 113 fluidly communicating with the second fluid passage 15. The first channel 112 and the first fluid passage 13 may be aligned with one another or they may fluidly communicate via a clearance between the cylindrical wall 110 of the well 106 and the outer cylindrical surface of the fitting 53.

A seal 55, for example, an O-ring seal, may be mounted between the fitting 53 and the receptacle 104 to seal any fluid in the first channel 112 and the first fluid passage 13 from the ambient environment. The seal 55 may be mounted, for example, between the flange 54 and the ledge 114 or between the outer cylindrical surface of the fitting 53 and the cylindrical wall 110 of the well 106. The seal 55 is axially positioned outboard of the intersection of the first fluid passage 13 with the outer cylindrical surface of the fitting 53 and outboard of the intersection of the first channel 112 with the cylindrical wall 110 of the well 106.

Another seal 56, for example, another O-ring seal, may be mounted between the fitting 53 and the receptacle 104 to seal any fluid in the first channel 112 or the first fluid passage 13 from any fluid in the second channel 113 or the second fluid passage 15. The seal 56 may be mounted between the outer cylindrical surface of the fitting 53 and the cylindrical wall 110 of the well 106 and may be axially positioned inboard of the intersection of the first fluid passage 13 with the outer cylindrical surface of the fitting 53 and inboard of the intersection of the first channel 112 with the cylindrical wall 110 of the well 106. Alternatively, the seal may be mounted in the bore of the inboard housing piece between an inner wall of the inboard housing piece and a hollow cylindrical boss (not shown) which extends into the bore from the base of the well.

In one mode of operation, lower pressure fluid from the filter outlet line 103 may be coupled to the outboard side 14 of the deflectable element 12 via the first channel 112 and the first fluid passage 13, while higher pressure fluid from the filter inlet line 102 may be coupled to the inboard side 16 of the deflectable element 12 via the second channel 113 and the second fluid passage 15. The deflection sensing circuit 20 responds to the deflection of the deflectable element 12 and provides a signal indicative of the differential pressure, which, for the fluid assembly 100 shown in FIG. 4, corresponds to the pressure drop through the filter element 101. With the deflectable element 12 and the deflection sensing circuit 20 located in the fitting 53 of the pressure sensing device 10 and in the well 106 of the pressure sensing port 105, the differential pressure is sensed with a minimum of manifolding outside the receptacle 104. Consequently, the pressure sensing device 10 provides a highly responsive and reliable indication of the differential pressure.

While pressure sensing devices and fluid assemblies embodying one or more aspects of the invention have been previously described and/or illustrated in the Figures, the invention is not limited to these embodiments. For instance, one or more of the features of these embodiments may be eliminated without departing from the scope of the invention. For example, one or more of the electronic components 25 and/or temperature sensors 26 may be eliminated from the chamber 24 of the housing 11. This may further reduce the size and weight of the pressure sensing device.

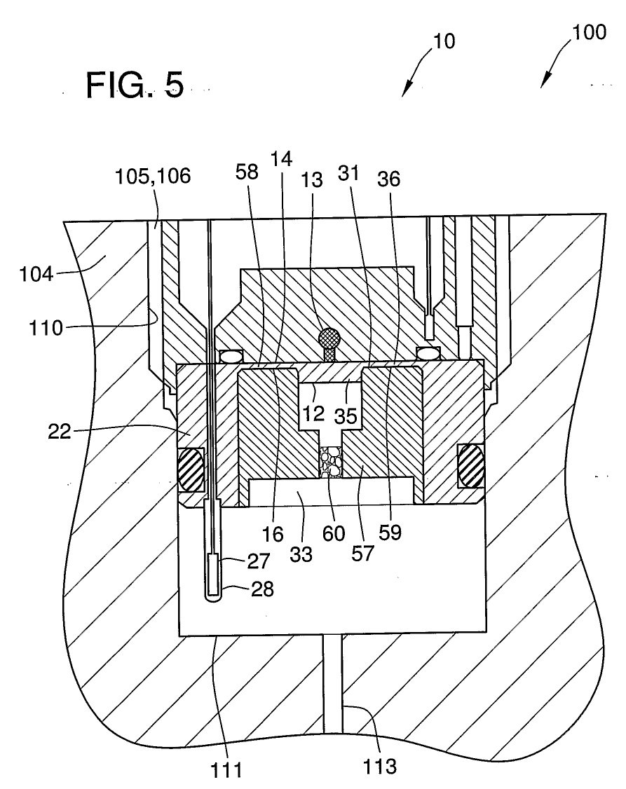

Further, one or more features of one embodiment may be combined with one or more features of other embodiments and/or one or more features of the embodiments may be modified without departing from the scope of the invention. For example, as shown in FIG. 5, a pressure sensing device 10 may include a temperature sensor 27 that extends through the housing 11 and into a reservoir or fluid line of the fluid assembly 100. This temperature sensor 27 may be configured as a probe having an encased end 28 sealed to the housing 11.

The pressure sensing device 10 shown in FIG. 5 may also include a second stop 57 arranged to limit deflection of the deflectable element 12 toward the second fluid passage 15 to a predetermined value. The second stop 57 may be useful if the fluid assembly 100 is subject to occasional reverse pressures where the pressure in the first fluid passage 13 may exceed the pressure in the second fluid passage 15 for a brief or extended period of time. Further, a pressure sensing device with stops on both sides of the deflectable element may be more versatile, allowing the higher pressure fluid to be coupled to either of the first fluid passage or the second fluid passage.

The second stop 57 may be configured in many different ways. In the embodiment shown in FIG. 5, the second stop 57 may comprise a hollow, cylindrical sleeve which may be inserted in the bore 33 of the inboard housing piece 22 and attached to the inboard piece 22 in any convenient manner. For example, the second stop 57 may be bonded, threaded or welded to the inboard piece 22. The second stop 57 may have an annular end face 58 which faces the inboard side 16 of the deflectable element 12 with a gap 59 between them. For example, the end face 58 of the second stop may face the inboard side of the thin annular section 36 of the diaphragm 12 with a gap 59 between them, allowing the thickened center section 35 to extend into the hollow interior of the sleeve 57. The thickness of the gap 59 facing the inboard side 16 of the diaphragm 12 may then limit the deflection of the diaphragm 12 toward the gap 59 in the same manner, and to a similar or different extent, as the thickness of the gap 31 facing the outboard side 14 limits the deflection of the diaphragm 12 toward that gap 31. To prevent foulants from fouling the second fluid passage 15, especially a thin gap 59, a porous filter material 60 may be mounted in the center of the sleeve 57.

Further, a pressure sensing device embodying the invention may be combined with other components, such as other sensing elements, to create a more multipurpose device. For example, the multipurpose device may also include additional temperature sensors, a gauge pressure sensor, a water content sensor, and/or a flow sensor, e.g., a device that senses differential pressure across an orifice.

What is claimed is:

1. A pressure sensing device comprising:
a housing and a first fluid passage and a second fluid passage associated with the housing;
a deflectable element having a first side and a second side, wherein the deflectable element is mounted to the housing with the first fluid passage coupled to the first side of the deflectable element and the second fluid passage coupled to the second side of the deflectable element;
a deflection sensing circuit supported by the first side of the deflectable element;
a layer of solid, insulative material supported by the first side of the deflectable element and overlying the deflection sensing circuit to electrically insulate the deflection sensing circuit from the first fluid passage.

2. The pressure sensing device of claim 1 further comprising an electrical connector coupled to the deflection sensing circuit and a seal positioned between the housing and the first side of the deflectable element, wherein the seal divides the first side of the deflectable element into an inner region which is coupled to the first fluid passage and an outer region which is isolated from the first fluid passage and wherein the electrical connector extends between the first and second regions of the first side of the deflectable element.

3. The pressure sensing device of claim 1 wherein the deflectable element comprises an impermeable diaphragm.

4. The pressure sensing device of claim 1 wherein the deflection sensing circuit includes a strain gauge.

5. The pressure sensing device of claim 1 wherein the deflection sensing circuit comprises a thin film strain gauge circuit.

6. The pressure sensing device of claim 1 wherein the layer of solid, insulative material comprises a thin layer of glass or ceramic deposited over the deflection sensing circuit.

7. The pressure sensing device of claim 1 wherein the layer of solid, insulative material comprises a first layer and the pressure sensing device further comprises a second layer of solid, inorganic, insulative material disposed between the deflection sensing circuit and the deflectable element.

8. The pressure sensing device of claim 7 wherein the second layer of solid, insulative material comprises a thin layer of glass or ceramic deposited between the deflection sensing arrangement and the first side of the deflectable element.

9. The pressure sensing device of claim 1 wherein the seal comprises a ring seal.

10. A pressure sensing device comprising:
a housing and a first fluid passage and a second fluid passage associated with the housing, the housing having a metal portion;
a deflectable metal diaphragm having a first side and a second side, the deflectable metal diaphragm being mounted to the metal portion of the housing with the first fluid passage coupled to the first side of the diaphragm and the second fluid passage coupled to the second side of the diaphragm;
a mechanical stop associated with the first side of the deflectable metal diaphragm and arranged to limit deflection of the diaphragm toward the first fluid passage to a predetermined value;
a deflection sensing circuit supported by the first side of the deflectable metal diaphragm, the deflection sensing circuit including first and second thin insulative layers and a thin-film strain gauge circuit positioned between the first and second insulative layers;
a seal disposed between the housing and the first side of the deflectable metal diaphragm, the seal defining an inner region of the first side of the diaphragm which includes the strain gauge circuit and is coupled to the first fluid passage and an outer region of the first side of the diaphragm which is isolated from the first fluid passage; and
an electrical connector associated with the thin-film strain gauge circuit and extending between the inner and outer regions of the first side of the deflectable metal diaphragm.

11. The pressure sensing device of clam 10 wherein the first insulative layer comprises a layer of inorganic material.

12. The pressure sensing device of claim 11 the inorganic material comprises glass.

13. The pressure sensing device of claim 10 further comprising a second mechanical stop associated with the second side of the deflectable metal diaphragm and arranged to limit deflection of the diaphragm toward the second fluid passage.

14. A fluid assembly comprising:
a fitting and a first fluid passage and a second fluid passage associated with the fitting;
a deflectable element mounted to the fitting and having a first side coupled to the first fluid passage and a second opposite side coupled to the second fluid passage;
a deflection sensing circuit supported by the first side of the deflectable element and including a thin-film strain gauge circuit;
an insulative layer supported by the first side of the deflectable element and overlying the deflection sensing circuit to electrically insulate the deflection sensing circuit from the first fluid passage; and
a receptacle including a pressure sensing port having a well arranged to receive the fitting with the deflectable element positioned within the well of the receptacle, the receptacle fluidly connecting the first fluid passage of the fitting to a source of a fluid at a first pressure and the second fluid passage of the fitting to a source of a fluid at a second pressure.
